(19) United States
(12) Patent Application Publication
(10) Pub. No.: US 2021/0289754 A1
(43) Pub. Date: Sep. 23, 2021

(54) CART FOR ASSISTING ANIMALS IN MOVEMENT

(71) Applicant: Nate Courteau, St. Paul, MN (US)

(72) Inventor: Nate Courteau, St. Paul, MN (US)

(21) Appl. No.: 16/823,606

(22) Filed: Mar. 19, 2020

(51) Int. Cl. A01K 29/00; A01K 27/00

(52) U.S. Cl. CPC A01K 29/00; A01K 27/002

(57) ABSTRACT

A cart for supporting either the fore quarters or the hind quarters of a disabled animal to allow for improved movement of the disabled animal. The cart configured for coupling to the animal and having a frame, the frame comprising a first rail and a second rail parallel to the first rail. The cart having a pair of hemispherical shaped wheels having an adjustable height and coupled to the first rail and the second rail. The cart including a halo having an arcuate shape that extends from the first rail to the second rail substantially surrounding the frame, wherein the halo is an exterior most structure of the device.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

This invention relates generally to a wheeled cart for use by animals, such as, but not limited to dogs, that do not have adequate capability for movement. In one aspect, the cart is configured for attachment to the animal to enable movement without the use of some of their appendages.

### BACKGROUND

It is known in the art that injured or incapacitated animals may be incapable of movement and be required to utilize a cart or cart-like device to aid in motion and movement. Within the prior art, there exist several styles and types of carts generally comprised of a harness assembly with wheels. U.S. Pat. No. 3,215,117 to Short, U.S. Pat. No. 3,406,661 to Parkes, and U.S. Pat. No. 4,375,203 to Parkes all disclose various cart assemblies and structures for use in suspending the hind limbs of a canine to enable the canine freedom of movement. Although having unique structural elements, each of these devices generally disclose a rectangular framed assembly with a pair of wheels connected to an axle for enabling movement by the animal. This rectangular frame and wheels, although helpful, does place limitations on the use of the device. Most generally, this rectangular frame is prone to catching on objects and not provided in an assembly that is generally free of angular bends and connecting portions. Additionally, the wheels on these devices are not ideal for movement on non-paved or smooth surfaces. Still further, these wheels, to utilize the working surface, require the cart to be fastened very securely to the animal, wherein side to side motion of the cart may render the wheels inoperable.

There exists a need for an improved cart device for assisting animals in movement. Preferably this cart is comprised of a frame that does not get stuck or hung up on objects and includes improved wheels that operate at multiple angles. Still further, it is preferred that his cart be adjustable and applicable to animals of varying sizes and types and useful to support the animal in both the hind quarters and fore quarters.

### BRIEF SUMMARY OF THE INVENTION

In one aspect, this disclosure is related to an improved cart for assisting in the movement of animals that is provided in a structure that enables navigation around objects.

In another aspect, this disclosure is related to an improved cart for assisting animals in movement across uneven surfaces and having an adjustable structure easily adapted to multiple sizes, types, and positions on an animal.

The device of the present disclosure comprises a frame assembly, a harness assembly, a supporting apparatus, and a pair of wheels. The frame assembly specifically comprising a pair of rails, the pair of rails parallel to each other extending from a first end to a second end. The frame assembly including a halo, the halo extending from a first rail around the second end to a second rail of the pair of rails. The halo generally forming an arcuate shape surrounding the second end to prevent catching of the device on objects.

The first end in configured for receipt of the harness assembly. The supporting apparatus and the pair of wheels in a coupling, wherein each wheel of the pair of wheels has an adjustable height. The wheels further specifically configured with a hemispherical shape to enable contact with a surface from multiple angles.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is an isometric view of the device, according to the present disclosure;

FIG. 2 is a top side view of the device, according to the present disclosure; and

FIG. 3 is a side view of the device, according to the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

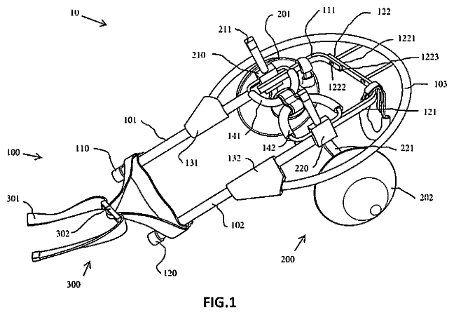

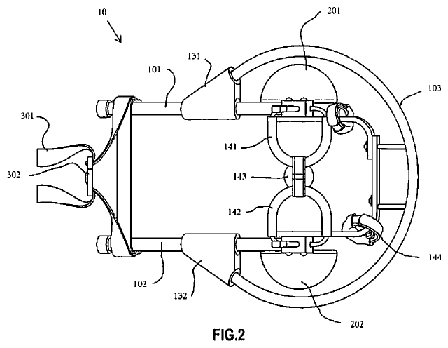

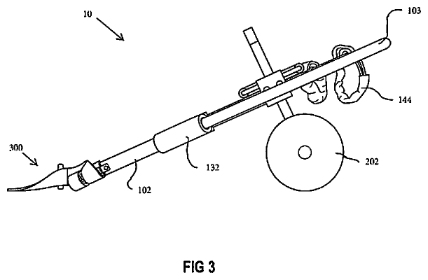

Referring now to FIGS. 1-3 of the present disclosure most generally related to a cart to assist movement for animals. The cart, generally referred to as device 10 comprises a rigid frame portion 100 supporting a pair of wheels 200. The rigid frame 100 comprised of a pair of rails with a first rail 101 and a second rail 102 parallel to the first rail 101. Each rail 101, 102 of the pair of rails having a first end 110, 120 and a second end 111, 121. The distance between the first end 110, 120 and the second end 111, 121 defining a length. The second end 111, 121 of each rail 101, 102 of the pair of rails in an adjustable coupling 122. The adjustable coupling 122 configured to enable an adjustment of a width between each rail 101, 102 of the pair of rails. Accordingly, the adjustable coupling 122 utilized to enable use of the device 10 by several widths of animals.

In the preferred embodiment of the present disclosure of the device 10, the adjustable coupling 122 generally comprising a collapsible/expanding cross member 1221 extending perpendicular between each rail 101, 102 at the second ends 121, 111. The adjustable coupling 122 preferably integrated into the second ends 121, 111 of each rail 101, 102 of the pair of rails. The adjustable coupling 122 in the preferred assembly being a raised detent 1222 configured for receipt in a plurality of apertures 1223, wherein the plurality of apertures 1223 having a size and a shape corresponding to the raised detent 1222. Accordingly, the plurality of apertures 1223 extending along the collapsible/expanding cross member 1221 to enable adjustment of the width of the device 10.

The first end 110, 120 of each rail 101, 102 configured for the receipt of a harness assembly 300. The harness assembly 300 comprised of at least one strap member 301 and a clasp 302. The at least one strap member 301 configured for placement around a torso of an animal and securing with the clasp 302. In the preferred embodiment of the present disclosure, the device 10 at least one strap member 301 comprised of a nylon webbing material with the clasp 302 being configured to enable for adjustment of the at least one strap member 301, wherein the at least one strap member 301 and the clasp 302 are utilized to fit the device 10 onto several sizes of animals.

The rigid frame assembly 100 including a halo 103. The halo 103 generally being arcuate in shape and extending from a first side portion 131 of the length of the first rail 101 around the second end 111 of the first rail 101 and the second end 121 of the second rail 102 to a second side portion 132 of the second rail 102. The halo 103 forming a barrier around an exterior of the rigid frame assembly 100 to prevent the rigid frame assembly 100 from catching on objects. The halo 103 arcuate shape having a dimension that extends around an entirety of the device 10, wherein the halo 103 is the exterior most contact point of the device 10. Accordingly, the halo 103 is the only structural element of the device 10 contacting objects exterior to the device 10 and extending to a position at least exterior to the pair of wheels 200. Therefore, the halo 103 preferably having an exterior surface that is comprised of a cushioned material, such as, but not limited to foam, to prevent the marring of objects the device 10 contacts.

In an alternate embodiment of the present disclosure, the halo 103 is comprised of a flexible and resilient material configured to provide cushioning in the event of a collision with an object.

The device 10 including a supporting apparatus 104 configured to support an animal within the device 10. The supporting apparatus 104 comprised of a first support 141 and a second support 142. The first support 141 and the second support 142 positioned at an interior of the frame 100 with the first support 141 affixed to the first rail 101 and the second support 142 affixed to the second rail 102. The first support 141 and the second support 142 forming a cavity for the receipt of a limb or limbs of the animal utilizing the device 10. Accordingly, the first support 141 and the second support 142 are preferably semi-circular in shape and include a padded surface to provide comfortable resting support to the retained animal. The first support 141 and the second support 142 may include a coupling in the form of a strap 143 coupled between the first support 141 and the second support 142. The strap 143 providing integrity and additional strength to first support 141 and the second support 142 for bearing the weight of the animal within the device 10. The device 10 may include additional strap members 144 to aid in securing a retained animal within the frame 100.

The pair of wheels 200 comprised of a first wheel 201 and a second wheel 202. The first wheel 201 positioned on the first rail 101 through a coupling with a first bracket 210. The first bracket 210 received on the first rail 101 along the length between the second end 111 and the first side position 131. The first wheel 201 affixed for rotation about an axis on a first leg 211. The first leg 211 having a height and movably received within the first bracket 210 along the height of the first leg 211. Accordingly, the first leg 211 allows for the independent adjustment of a height of the first wheel 201.

The second wheel 202 positioned on the second rail 102 through a coupling with a second bracket 220. The second bracket 220 received on the second rail 102 along the length between the second end 121 and the second side position 132. The second wheel 202 affixed for rotation about an axis on a second leg 221. The second leg 221 having a height and movably received within the second bracket 220 along the height of the second leg 221. Accordingly, the second leg 221 allows for the independent adjustment of a height of the second wheel 202.

The pair of wheels 200 in the form of the first wheel 201 and the second wheel 202 specifically configured with a hemispherical shape. The hemispherical shape of the wheels 200 specifically selected to enable contact with a surface from multiple positions and angles.

The device 10 of the present disclosure is configured with an assembly to enable use by multiple animal types, sizes, and positions. Accordingly, the animal may be placed into the supporting apparatus 104 at both the hind quarters and fore quarters. Accordingly, the device 10 may be generally pulled or pushed by the animal with the halo 103 ensuring that the device 10 does not catch on any objects contacted during use.

In yet another alternate embodiment of the present disclosure, the device 10, despite its robust assembly and halo 103 may have a tendency to tip when an animal received within the device 10 may change their direction at speed, especially during bouts of exuberant play. It's not uncommon, especially with larger dogs, that the cart they're using will tip over, as the wheelbase cannot support the inertia encountered at the abrupt turn. To combat any tendencies to tip, the device 10 may be fitted with a retractable brace (not pictured) to further extend the footprint of the device 10 beyond the halo 103. This retractable brace could be placed on either side of the device 10 and include a spring-loaded mechanism to enable movement of the retractable brace from a first retained position to a second extended position. Accordingly, if the device 10 were to begin tipping, the spring-loaded mechanism would activate and move the retractable brace to the second extended position. Preferably, to prevent jarring of the device 10 and prevent the retractable brace from functioning as a brake, the retractable brace may be fitted with wheels to help slow the carts tipping momentum, but not brake.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A cart for supporting an animal for movement, the cart comprising:
a frame, the frame comprising a first rail and a second rail, the frame configured for coupling to the animal;
a pair of hemispherical shaped wheels, a first hemispherical shaped wheel of the pair of hemispherical shaped wheels coupled to the first rail, and a second hemispherical shaped wheel of the pair of hemispherical shaped wheels coupled to the second rail; and
a halo, the halo arcuate in shape and extending from the first rail to the second rail, the halo substantially surrounding the frame, wherein the halo is an exterior most structure of the device.

2. The cart as in claim 1, wherein each of the first hemispherical shaped wheel and the second hemispherical shaped wheel are adjustable a height.

3. The cart as in claim 1, wherein the first rail and the second rail are coupled to each to define a width.

4. The cart as in claim 3, wherein the width is adjustable.

5. The cart as in claim 1, wherein the first frame includes a first support and the second frame includes a second support.

6. The cart as in claim 5, wherein the first support and the second support are coupled together with a strap.

7. The cart as in claim 1, wherein the frame includes a retractable brace from a first retracted position to a second extended position to prevent tipping.

8. A cart for suspending a portion of a disabled animal to encourage movement, the cart comprising:
a frame, the frame being rigid and comprising:
a first rail, the first rail having a first end, a second end, and a first support, the first support positioned between the first end and the second end;
a second rail, the second rail positioned parallel to the first rail, the second rail having a first end, a second end, and a second support, the second support positioned between the first end and the second end of the second rail; and
a halo, the halo extending from a first side portion of the first rail around the second end of the first rail and the second end of the second rail to a second side portion of the second rail, wherein the halo is arcuate in shape and surrounding the second ends, the halo being an external most structure of the cart;
a harness assembly, the harness assembly extending between the first end of the first rail and the first end of the second rail, the harness assembly configured for coupling to the disabled animal; and
a pair of hemispherical shaped wheels, a first hemispherical shaped wheel of the pair of hemispherical shaped wheels coupled to the first rail, and a second hemispherical shaped wheel of the pair of hemispherical shaped wheels coupled to the second rail.

9. The cart as in claim 8, wherein each of the first hemispherical shaped wheel and the second hemispherical shaped wheel are adjustable a height.

10. The cart as in claim 8, wherein the first rail and the second rail are coupled to each to define a width.

11. The cart as in claim 10, wherein the width is adjustable.

12. The cart as in claim 8, wherein the first support and the second support are coupled together with a strap.

13. The cart as in claim 8, wherein the harness assembly comprises an adjustable strap member and a clasp.

14. An apparatus for suspending and receiving at least a portion of a disabled animal to encourage movement, the apparatus comprising:
a rigid frame, the rigid frame comprising:
a first rail, the first rail having a first end, a second end, and a first support, the first support positioned between the first end and the second end at an interior space of the rigid frame;
a second rail, the second rail positioned parallel to the first rail, the second rail having a first end, a second end, and a second support, the second support positioned between the first end and the second end of the second rail at the interior space of the rigid frame; and
a halo, the halo extending from an exterior of the rigid frame at a first side portion of the first rail around the second end of the first rail and the second end of the second rail to a second side portion of the second rail, wherein the halo is arcuate in shape and surrounding the second ends, the halo being the external most structure of the apparatus;
a harness assembly, the harness assembly extending between the first end of the first rail and the first end of the second rail, the harness assembly configured for coupling to the disabled animal; and
a pair of hemispherical shaped wheels, a first hemispherical shaped wheel of the pair of hemispherical shaped wheels coupled to the first rail, and a second hemispherical shaped wheel of the pair of hemispherical shaped wheels coupled to the second rail.

15. The apparatus as in claim 14, wherein each of the first hemispherical shaped wheel and the second hemispherical shaped wheel are adjustable a height.

16. The apparatus as in claim 14, wherein the first rail and the second rail are coupled to each to define a width.

17. The apparatus as in claim 16, wherein the width is adjustable.

18. The apparatus as in claim 14, wherein the first support and the second support are coupled together with a strap.

19. The apparatus as in claim 14, wherein the harness assembly comprises an adjustable strap member and a clasp.

20. The apparatus as in claim 14, wherein the halo has a padded surface.
